(19) United States
(12) Patent Application Publication
(10) Pub. No.: US 2022/0309969 A1
(43) Pub. Date: Sep. 29, 2022

(54) DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventors: Yi Li, Shenzhen (CN); Xiaojin He, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 17/057,636

(22) PCT Filed: Oct. 20, 2020
(86) PCT No.: PCT/CN2020/122161

§ 371 Date: Nov. 20, 2020

(30) Foreign Application Priority Data
Sep. 2, 2020 (CN) 202010907864.7

(51) Int. Cl. G09G 3/00

(52) U.S. Cl. CPC G09G 3/006; G09G 2330/12; G09G 2300/0408; G09G 2310/0262

(57) ABSTRACT

A display panel includes at least two chip-on-film (COF) binding regions, at least one voltage signal terminal disposed between two adjacent COF binding regions, and at least one shorting bar. Each shorting bar is connected to one voltage signal terminal and two COF binding regions adjacent to the voltage signal terminal. The shorting bar includes a first closed loop line and a second closed loop line. The first closed loop line is connected to the voltage signal terminal to define a first closed loop. The second closed loop line is connected to the voltage signal terminal to define a second closed loop.

### FIELD OF INVENTION

The present disclosure relates to the field of display technology, and particularly relates to a display panel.

### BACKGROUND OF INVENTION

Cell test pads are designed between two chip-on-film (COF) binding regions in general liquid crystal displays to facilitate screen inspection of cell (liquid crystal cell) processes. Because a number of chips on film in tri-gate structure products is less than products with general structures, they can effectively reduce the number of the chips. However, in current design solutions and in a same dimensional condition, because the number of the chips on film in tri-gate structure products is less, distances between adjacent COF binding regions of the tri-gate products are far. Data lines away from the cell test pads receive attenuated voltage signals due to RC delay. Moreover, the farther signal lines are from the cell test pads, the more severe a signal attenuation is, thereby resulting in color shift easily generating during the screen inspection of the cell processes, and affecting judgement of inspectors.

### SUMMARY OF INVENTION

Embodiments of the present disclosure provides a display panel to solve a technical problem that due to a less number of chips on film in the current tri-gate structure products, the distances between the adjacent COF binding regions of the tri-gate products are far, and the data lines far from the cell test pads receive attenuated voltage signals due to the RC delay, resulting in color shift easily generating during the screen inspection of cell processes, and affecting judgement of inspectors.

In order to solve the problems mentioned above, the present disclosure provides the technical solutions as follows:

One embodiment of the present disclosure further provides another display panel, including at least two chip-on-film (COF) binding regions, at least one voltage signal terminal, and at least one shorting bar. Each of the COF binding regions is correspondingly connected to a plurality of data lines. At least one of the voltage signal terminals is disposed between two adjacent COF binding regions. Each of the shorting bars is connected to one voltage signal terminal and two of the COF binding regions adjacent to the voltage signal terminals. Furthermore, the shorting bar includes a first closed loop line and a second closed loop line. The first closed loop line is connected to the voltage signal terminal to define a first closed loop. The second closed loop line is connected to the voltage signal terminal to define a second closed loop. The first closed loop line is connected to one of the COF binding regions adjacent to the voltage signal terminal. The second closed loop line is connected to another COF binding region adjacent to the voltage signal terminal. A plurality of first leads distributed side by side and a plurality of second leads distributed side by side are disposed on the COF binding regions. The plurality of first leads are correspondingly connected to the plurality of data lines one by one. The plurality of second leads are connected to the first closed loop line or the second closed loop line.

In at least embodiment of the present disclosure, a first voltage signal terminal, a second voltage signal terminal, and a third voltage signal terminal distributed side by side are disposed between the two adjacent COF binding regions.

In at least embodiment of the present disclosure, the display panel includes a first shorting bar, a second shorting bar, and a third shorting bar correspondingly connected to the first voltage signal terminal, the second voltage signal terminal, and the third voltage signal terminal respectively.

In at least embodiment of the present disclosure, a peripheral wiring of the second shorting bar is arranged around the first shorting bar, and a peripheral wiring of the third shorting bar is arranged around the second shorting bar.

In at least embodiment of the present disclosure, the display panel further includes a first metal layer and a second metal layer insulated from each other.

In at least embodiment of the present disclosure, a peripheral wiring of the first shorting bar, the peripheral wiring of the second shorting bar, and the peripheral wiring of the third shorting bar are disposed on a same layer with the first metal layer, and a bridging line of the second shorting bar and a bridging line of the third shorting bar are disposed on a same layer with the second metal layer.

In at least embodiment of the present disclosure, the display panel includes a plurality of pixel units distributed in an array manner, and the pixel units include a plurality of first subpixels, a plurality of second subpixels, and a plurality of third subpixels arranged along an extending direction of the data lines.

In at least embodiment of the present disclosure, the first voltage signal terminal inputs voltage signals to the plurality of first subpixels, the second voltage signal terminal inputs voltage signals to the plurality of second subpixels, and the third voltage signal terminal inputs voltage signals to the plurality of third subpixels.

One embodiment of the present disclosure further provides another display panel, including at least two chip-on-film (COF) binding regions, at least one voltage signal terminal, and at least one shorting bar. Each of the COF binding regions is correspondingly connected to a plurality of data lines. At least one of the voltage signal terminals is disposed between two adjacent COF binding regions. Each of the shorting bars is connected to one voltage signal terminal and two of the COF binding regions adjacent to the voltage signal terminals. Furthermore, the shorting bar includes a first closed loop line and a second closed loop line. The first closed loop line is connected to the voltage signal terminal to define a first closed loop. The second closed loop line is connected to the voltage signal terminal to define a second closed loop.

In at least embodiment of the present disclosure, the first closed loop line is connected to one of the COF binding regions adjacent to the voltage signal terminal, the second closed loop line is connected to another COF binding region adjacent to the voltage signal terminal.

In at least embodiment of the present disclosure, a plurality of first leads distributed side by side and a plurality of second leads distributed side by side are disposed on the COF binding regions, the plurality of first leads are correspondingly connected to the plurality of data lines one by one, and the plurality of second leads are connected to the first closed loop line or the second closed loop line.

In at least embodiment of the present disclosure, a first voltage signal terminal, a second voltage signal terminal, and a third voltage signal terminal distributed side by side are disposed between the two adjacent COF binding regions.

In at least embodiment of the present disclosure, the display panel includes a first shorting bar, a second shorting bar, and a third shorting bar correspondingly connected to the first voltage signal terminal, the second voltage signal terminal, and the third voltage signal terminal respectively.

In at least embodiment of the present disclosure, a peripheral wiring of the second shorting bar is arranged around the first shorting bar, and a peripheral wiring of the third shorting bar is arranged around the second shorting bar.

In at least embodiment of the present disclosure, the display panel further includes a first metal layer and a second metal layer insulated from each other.

In at least embodiment of the present disclosure, a peripheral wiring of the first shorting bar, the peripheral wiring of the second shorting bar, and the peripheral wiring of the third shorting bar are disposed on a same layer with the first metal layer, and a bridging line of the second shorting bar and a bridging line of the third shorting bar are disposed on a same layer with the second metal layer.

In at least embodiment of the present disclosure, the display panel includes a plurality of pixel units distributed in an array manner, the pixel units include a plurality of first subpixels, a plurality of second subpixels, and a plurality of third subpixels arranged along an extending direction of the data lines.

In at least embodiment of the present disclosure, the first voltage signal terminal inputs voltage signals to the plurality of first subpixels, the second voltage signal terminal inputs voltage signals to the plurality of second subpixels, and the third voltage signal terminal inputs voltage signals to the plurality of third subpixels.

In at least embodiment of the present disclosure, one of the pixel units is driven by three scanning lines and one data line together.

In at least embodiment of the present disclosure, the first subpixels, the second subpixels, and the third subpixels are respectively one of red subpixels, green subpixels, or blue second subpixels.

Two ends of the shorting bars are configured to connect to the voltage signal terminals, so that the voltage signals are input from the voltage signal terminals, thereby making the data lines connected to two sides of the COF binding regions have same signal inputs, realizing double-driving effect, thereby reducing attenuation of the signals during transmission processes, and further reducing color shift risk generating on the display screens.

### DESCRIPTION OF DRAWINGS

FIG. 1 is a wiring principle schematic diagram of shorting bars provided by one embodiment of the present disclosure.

FIG. 2 is another wiring principle schematic diagram of the shorting bars provided by one embodiment of the present disclosure.

FIG. 3 is a structural schematic diagram of a display panel provided by one embodiment of the present disclosure.

### DETAILED DESCRIPTION OF PREFERRED EMBODIMENTS

The present disclosure provides a display panel. For making the purposes, technical solutions and effects of the present disclosure be clearer and more definite, the present disclosure will be further described in detail below. It should be understood that the specific embodiments described herein are merely for explaining the present disclosure and are not intended to limit the present disclosure.

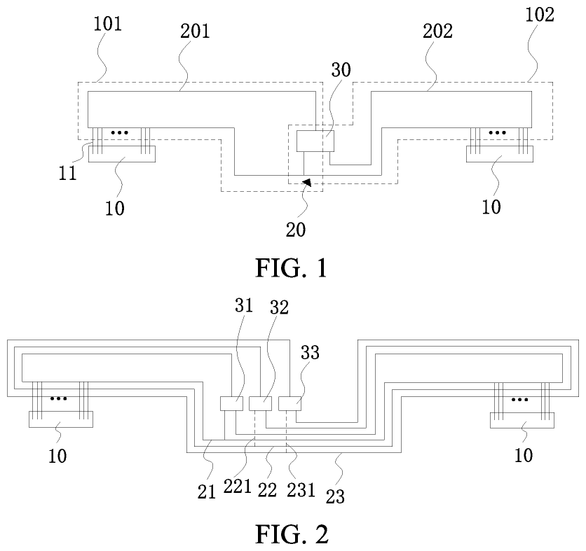

Please refer to FIG. 1, one embodiment of the present disclosure provides a display panel, including at least two chip-on-film (COF) binding regions 10, at least one voltage signal terminal 30, and at least one shorting bar 20. Each of the COF binding regions 10 is correspondingly connected to a plurality of data lines. At least one of the voltage signal terminals 30 is disposed between two adjacent COF binding regions. Each of the shorting bars 20 is connected to one voltage signal terminal 30 and two of the COF binding regions 10 connected to the voltage signal terminals.

The voltage signal terminals 30 are used as input ports of voltage signals to input the voltage signals from the voltage signal terminals 30 during inspection of cell processes. The voltage signals are input into the data lines connected to the COF binding regions by the shorting bars 20, so pixels in the panel are lit up.

Comparing tri-gate structure display panels to general display panels, a number on scanning lines is tripled, and a number of data lines is reduced to one-third of the original, thereby reducing a number of source drivers, and reducing cost of the source drivers. Therefore, the required number of COF can be reduced, resulting in increased distances between the adjacent COF binding regions 10, thereby causing severe RC delay generating on the data lines connected to the COF binding regions 10 far away from the voltage signal terminals 30 during signal transmission, making charging speed of pixels of two sides of the display panel significantly lag behind pixels of middle of the panel. Uneven charging of each of the pixels of the panel can cause problems of generation of color shift on a screen displayed on the panel and affecting display quality.

Embodiments of the present disclosure improve a structure of the shorting bars 20 connected to the voltage signal terminals 30 and the COF binding regions, by connecting two ends of the shorting bars 20 into the voltage signal terminals 30, the voltage signals are input from the two ends of the voltage signal terminals 30, thereby reducing the screen color shift problem on the data lines on two sides of the COF binding regions incurred by receiving uneven signals.

Specifically, the shorting bar 20 includes a first closed loop line 201 and a second closed loop line 202. The first closed loop line 201 is connected to the voltage signal terminal 30 to define a first closed loop 101. The second closed loop line 202 is connected to the voltage signal terminal 30 to define a second closed loop 102.

In one embodiment, the first closed loop line 201 is further connected to one of the COF binding regions 10 (on left side of FIG. 1) adjacent to the voltage signal terminal 30 for transmitting voltage signals to the data lines connected to the COF binding region 10, and the second closed loop line 202 is further connected to another COF binding region 10 (on right side of FIG. 1) adjacent to the voltage signal terminal 30 for transmitting the voltage signals to the data lines connected to the COF binding region 10.

In one embodiment, a plurality of first leads distributed side by side and a plurality of second leads 11 distributed side by side are disposed on the COF binding regions 10. The plurality of first leads are correspondingly connected to the plurality of data lines one by one (not shown in the figure, please refer to a wiring manner of the prior art), and the plurality of second leads 11 are connected to the first closed loop line 201 or the second closed loop line 202. Specifically, the first leads and the second leads 11 can be disposed oppositely on top and bottom sides of the COF binding regions 10.

Please refer to FIG. 1, taking the first closed loop 101 as an example, the voltage signals are input into the first closed loop line 201 from a top end and a bottom end of the voltage signal terminals 30 during testing of the cell process, making the data lines on two ends of left side COF binding regions able to have same inputs of voltages and electric currents, realizing double-driving effect, thereby improving the problem of screen color shift.

The embodiments of the present disclosure are not only suitable for tri-gate products, but are also suitable for products having differences of signal transmission on different regions incurred by far distances between COF binding regions.

Please refer to FIG. 2, in one embodiment, three voltage signal terminals can be disposed side by side between the two adjacent COF binding regions 10, that is, a first voltage signal terminal 31, a second voltage signal terminal 32, and a third voltage signal 33.

Correspondingly, the display panel further includes a first shorting bar 21, a second shorting bar 22, and a third shorting bar 23 correspondingly connected to the first voltage signal terminal 31, the second voltage signal terminal 32, and the third voltage signal terminal 33, respectively.

Each of the voltage signal terminals can correspond to voltage signal inputs of subpixels with one color, for example, the first voltage signal terminal 31 can correspond to a voltage signal input of red subpixels, the second voltage signal terminal 32 can correspond to a voltage signal input of green subpixels, and the third voltage signal terminal 33 can correspond to a voltage signal input of blue subpixels.

It can be understood that loop structures of the first shorting bar 21, the second shorting bar 22, and the third shorting bar 23 are same as loop structures of the shorting bars 20 illustrated in FIG. 1 mentioned above, and corresponding COF binding regions 10 and the connection manner are same, so redundant description will not be mentioned herein again.

Because the closed loop is defined after the first shorting bar 21, the second shorting bar 22, and the third shorting bar 23 are connected to corresponding voltage signal terminals, an annular encircling manner can be selected for wiring.

The second shorting bar 22 can be arranged around the first shorting bar 21, and the third shorting bar 23 can be arranged around the second shorting bar 22, using this wiring winding manner can reduce wiring space.

Because each of the shorting bars includes the first closed loop line and the second closed loop line, jumper wire regions are required to dispose on the second shorting bar 22 and the third shorting bar 23, thereby preventing short circuit incurred by connecting to other wiring.

Specifically, please refer to FIG. 2, the peripheral wiring of the second shorting bar 22 is arranged around the first shorting bar 21, and a peripheral wiring of the third shorting bar 23 is arranged around the second shorting bar 22. The jumper wire region of the second shorting bar 22 and the jumper wire region of the third shorting bar can be connected through bridging lines.

Generally, the display panel includes a first metal layer and a second metal layer, and wiring of the three shorting bars mentioned above can be realized by patterning the first metal layer and the second metal layer.

For example, the first shorting bar 21 has no jumper wire region, so all wiring of the first shorting bar 21 can be formed by patterning the first metal layer. The peripheral wiring of the second shorting bar 22 and the peripheral wiring of the third shorting bar 23 can also be formed by patterning the first metal layer.

That is, the first shorting bar 21, the peripheral wiring of the second shorting bar 22, and the peripheral wiring of the third shorting bar 23 are disposed on a same layer with the first metal layer, which can decrease processes.

A section of the jumper wire region (bridging line 221) of the second shorting bar 22 and a section of the jumper wire region (bridging line 231) of the third shorting bar 23 are disposed on a same layer with the second metal layer.

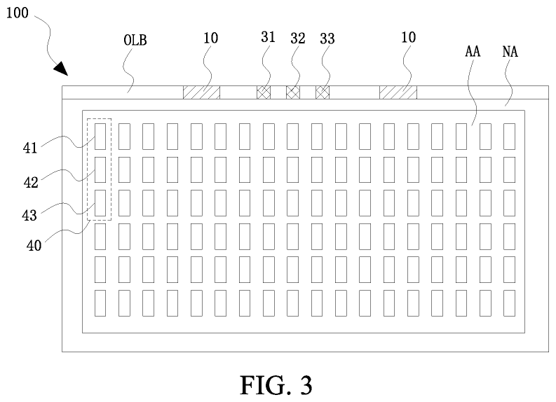

Please refer to FIG. 3, taking the tri-gate products as an example for description, because a number of the data lines of the tri-gate products is greatly reduced, the display panel 100 of the embodiments of the present disclosure can include two COF binding regions 10, and three voltage signal terminals disposed side by side between the two adjacent COF binding regions 10, that is the first voltage signal terminal 31, the second voltage signal terminal 32, and the third voltage signal terminal 33. Two of the COF binding regions 10 respectively control input of the voltage signals of the data lines of a half regions of the display panel 100.

The description about the first voltage signal terminal 31, the second voltage signal terminal 32, and the third voltage signal terminal 33 can refer to the embodiments of FIG. 1 and FIG. 2, and redundant description will not be mentioned herein again.

The display panel 100 includes a display region AA for display and a non-display region NA. The non-display region NA further includes an outer lead bonding region OLB disposed on one side of the display region AA. The COF binding regions 10 and the three voltage signal terminals are disposed in the outer lead bonding region OLB, so that the signals are input into the display region during inspection of the cell processes.

The display panel 100 includes a plurality of pixel units 40 distributed in an array manner. The pixel units 40 include first subpixels 41, second subpixels 42, and third subpixels 43 arranged along an extending direction of the data lines.

The pixel units 40 are disposed in the display region AA, and one of the pixel units 40 is driven by three scanning lines and one data line together.

The first subpixels 41, the second subpixels 42, and the third subpixels 43 are respectively one of red subpixels, green subpixels, or blue subpixels.

Each of the voltage signal terminals corresponds to voltage signal inputs of subpixels with one color, for example, the first voltage signal terminal 31 can correspond to a voltage signal input of red subpixels, the second voltage signal terminal 32 can correspond to a voltage signal input of green subpixels, and the third voltage signal terminal 33 can correspond to a voltage signal input of blue subpixels.

Specifically, the first voltage signal terminal 31 inputs voltage signals to the plurality of first subpixels 41, the second voltage signal terminal 32 inputs voltage signals to the plurality of second subpixels 42, and the third voltage signal terminal 33 inputs voltage signals to the plurality of third subpixels 43.

Because only two COF binding regions 10 are disposed in the embodiment illustrated in FIG. 3, the first voltage signal terminal 31 controls voltage signal input of all the first subpixels 41, the second voltage signal terminal 32 controls voltage signal input of all the second subpixels 42, and the third voltage signal terminal 33 controls voltage signal input of all the third subpixels 43.

In other embodiments, regarding large-sized display panels, more than two COF binding regions can be disposed. Correspondingly, a number of the voltage signal terminals for controlling the subpixels with a same color is correspondingly increased, thereby controlling signal input of the subpixels of different regions.

Two ends of the shorting bars are configured to connect to the voltage signal terminals, so that the voltage signals are input from the voltage signal terminals, thereby making the data lines connected to two sides of the COF binding regions have same signal inputs, realizing double-driving effect, thereby reducing attenuation of the signals during transmission processes, and further reducing color shift risk generating on the display screens.

In the above embodiments, the description of each embodiment has its emphasis, and for some embodiments that may not be detailed, reference may be made to the relevant description of other embodiments.

It can be understood, that for those of ordinary skill in the art, various other corresponding changes and modifications can be made according to the technical solutions and technical ideas of the present disclosure, and all such changes and modifications are intended to fall within the scope of protection of the claims of the present disclosure.

What is claimed is:

1. A display panel, comprising:
at least two chip-on-film (COF) binding regions, wherein each of the COF binding regions is correspondingly connected to a plurality of data lines;
at least one voltage signal terminal disposed between two adjacent COF binding regions; and
at least one shorting bar, wherein each shorting bar is connected to one voltage signal terminal and two of the COF binding regions adjacent to the voltage signal terminals,
wherein the shorting bar comprises a first closed loop line and a second closed loop line, the first closed loop line is connected to the voltage signal terminal to define a first closed loop, and the second closed loop line is connected to the voltage signal terminal to define a second closed loop;
the first closed loop line is connected to one of the COF binding regions adjacent to the voltage signal terminal, and the second closed loop line is connected to another COF binding region adjacent to the voltage signal terminal; and
a plurality of first leads distributed side by side and a plurality of second leads distributed side by side are disposed on the COF binding regions, the plurality of first leads are correspondingly connected to the plurality of data lines one by one, and the plurality of second leads are connected to the first closed loop line or the second closed loop line.

2. The display panel as claimed in claim 1, wherein a first voltage signal terminal, a second voltage signal terminal, and a third voltage signal terminal distributed side by side are disposed between the two adjacent COF binding regions.

3. The display panel as claimed in claim 2, wherein the display panel comprises a first shorting bar, a second shorting bar, and a third shorting bar correspondingly connected to the first voltage signal terminal, the second voltage signal terminal, and the third voltage signal terminal, respectively.

4. The display panel as claimed in claim 3, wherein a peripheral wiring of the second shorting bar is arranged around the first shorting bar, and a peripheral wiring of the third shorting bar is arranged around the second shorting bar.

5. The display panel as claimed in claim 4, wherein the display panel comprises a first metal layer and a second metal layer insulated from each other.

6. The display panel as claimed in claim 5, wherein a peripheral wiring of the first shorting bar, the peripheral wiring of the second shorting bar, and the peripheral wiring of the third shorting bar are disposed on a same layer with the first metal layer, and a bridging line of the second shorting bar and a bridging line of the third shorting bar are disposed on a same layer with the second metal layer.

7. The display panel as claimed in claim 2, wherein the display panel comprises a plurality of pixel units distributed in an array manner, and the pixel units comprise a plurality of first subpixels, a plurality of second subpixels, and a plurality of third subpixels arranged along an extending direction of the data lines.

8. The display panel as claimed in claim 7, wherein the first voltage signal terminal inputs voltage signals to the plurality of first subpixels, the second voltage signal terminal inputs voltage signals to the plurality of second subpixels, and the third voltage signal terminal inputs voltage signals to the plurality of third subpixels.

9. A display panel, comprising:
at least two chip-on-film (COF) binding regions, wherein each of the COF binding regions is correspondingly connected to a plurality of data lines;
at least one voltage signal terminal disposed between two adjacent COF binding regions; and
at least one shorting bar, wherein each shorting bar is connected to one voltage signal terminal and two of the COF binding regions adjacent to the voltage signal terminals,
wherein the shorting bar comprises a first closed loop line and a second closed loop line, the first closed loop line is connected to the voltage signal terminal to define a first closed loop, and the second closed loop line is connected to the voltage signal terminal to define a second closed loop.

10. The display panel as claimed in claim 9, wherein the first closed loop line is connected to one of the COF binding regions adjacent to the voltage signal terminal, and the second closed loop line is connected to another COF binding region adjacent to the voltage signal terminal.

11. The display panel as claimed in claim 9, wherein a plurality of first leads distributed side by side and a plurality of second leads distributed side by side are disposed on the COF binding regions, the plurality of first leads are correspondingly connected to the plurality of data lines one by one, and the plurality of second leads are connected to the first closed loop line or the second closed loop line.

12. The display panel as claimed in claim 9, wherein a first voltage signal terminal, a second voltage signal terminal, and a third voltage signal terminal distributed side by side are disposed between the two adjacent COF binding regions.

13. The display panel as claimed in claim 12, wherein the display panel comprises a first shorting bar, a second shorting bar, and a third shorting bar correspondingly connected to the first voltage signal terminal, the second voltage signal terminal, and the third voltage signal terminal, respectively.

14. The display panel as claimed in claim 13, wherein a peripheral wiring of the second shorting bar is arranged around the first shorting bar, and a peripheral wiring of the third shorting bar is arranged around the second shorting bar.

15. The display panel as claimed in claim 14, wherein the display panel comprises a first metal layer and a second metal layer insulated from each other.

16. The display panel as claimed in claim 15, wherein a peripheral wiring of the first shorting bar, the peripheral wiring of the second shorting bar, and the peripheral wiring of the third shorting bar are disposed on a same layer with the first metal layer, and a bridging line of the second shorting bar and a bridging line of the third shorting bar are disposed on a same layer with the second metal layer.

17. The display panel as claimed in claim 12, wherein the display panel comprises a plurality of pixel units distributed in an array manner, and the pixel units comprise a plurality of first subpixels, a plurality of second subpixels, and a plurality of third subpixels arranged along an extending direction of the data lines.

18. The display panel as claimed in claim 17, wherein the first voltage signal terminal inputs voltage signals to the plurality of first subpixels, the second voltage signal terminal inputs voltage signals to the plurality of second subpixels, and the third voltage signal terminal inputs voltage signals to the plurality of third subpixels.

19. The display panel as claimed in claim 17, wherein one of the pixel units is driven by three scanning lines and one data line together.

20. The display panel as claimed in claim 17, wherein the first subpixels, the second subpixels, and the third subpixels are respectively one of red subpixels, green subpixels, or blue second subpixels.
